(19) United States
(12) Patent Application Publication
(10) Pub. No.: US 2017/0003435 A1
(43) Pub. Date: Jan. 5, 2017

(54) NARROW-FRAME LIQUID CRYSTAL DISPLAY (LCD) MODULE

(71) Applicant: SHENZHEN CHINA STAR OPTOELECTRONICS TECHNOLOGY CO., LTD., Shenzhen, Guangdong (CN)

(72) Inventor: Jiangfeng WANG, Shenzhen, Guangdong (CN)

(21) Appl. No.: 14/647,114

(22) PCT Filed: Apr. 10, 2014
(86) PCT No.: PCT/CN2014/075119

§ 371 Date: May 25, 2015

(30) Foreign Application Priority Data
Mar. 27, 2014 (CN) 201410118189.4

(51) Int. Cl. F21V 8/00

(52) U.S. Cl. CPC G02B 6/0053; G02B 6/0088

(57) ABSTRACT

The present invention relates to a narrow-frame liquid crystal display (LCD) module, which comprises: an LCD panel; a light guide module including at least one group of optical films and a light guide plate disposed at the rear of the optical films; and a frame erected on the light guide plate and configured to support the edges of the optical films, wherein a prism layer is disposed among the optical films; the prism layer and the frame are partially overlapped or not overlapped; and when the prism layer and the frame are partially overlapped, the width of the prism layer extended from the frame is not more than 2 mm so as to shorten a dark band produced by the dioptric imaging of the frame on the edge of the LCD panel.

### FIELD OF THE INVENTION

The present invention relates to a liquid crystal display (LCD) module, in particular to a narrow-frame LCD module.

### BACKGROUND OF THE INVENTION

Currently, narrow-frame LCD modules are more and more popular due to the characteristics of large display area, beautiful appearance and the like. In the traditional narrow-frame LCD module, a frame is pressed on a light guide plate; an optical film is disposed above the frame; and in order to achieve the predetermined brightness, the optical film generally includes a prism lens which will allow an object below the prism lens to be imaged. Therefore, as illustrated in FIGS. 1 and 2, when the prism lens is disposed above the frame, the frame will be imaged by the prism lens; an image of the frame is projected into a display area of the LCD module; and hence a dark band will be formed on the edge of the LCD module. When the width of the prism lens covering the frame is 2.5 to 3.5 mm, a dark band with the width of 2-3 mm will be produced on the edge of the LCD module, and hence the display effect will be affected.

### SUMMARY OF THE INVENTION

In order to solve the above technical problem, the present invention provides a narrow-frame LCD module capable of shortening a dark band produced by the projection imaging of the frame, on the edge of the LCD panel, on the prism layer and hence optimizing the display effect.

The present invention provides a narrow-frame LCD module, which comprises: an LCD panel;

a light guide module including at least one group of optical films and a light guide plate disposed at the rear of the optical films; and

a frame erected on the light guide plate and configured to support the edges of the optical films, wherein

a prism layer is disposed among the optical films; the prism layer and the frame are partially overlapped or not overlapped; and when the prism layer and the frame are partially overlapped, the width of the prism layer extended from the frame is not more than 2 mm so as to shorten a dark band produced by the dioptric imaging of the frame on the edge of the LCD panel.

Optically, when the prism layer and the frame are partially overlapped, the width of the prism layer extended from the frame is not more than 0.7 mm; and when the prism layer and the frame are not overlapped, the difference of the spacing between the prism layer and the frame is 0 to 3 mm. The dark band produced by the imaging of the frame through the prism layer is shortened by the control of the distance of the prism layer extended or away from the frame.

Optically, the LCD module further comprises a radiating assembly and a light guide plate; one end of the frame is fixed on the radiating assembly and the other end of the frame is overlapped on the light guide plate; the light guide plate is disposed at the rear of the optical film; the optical film is supported above the light guide plate through the frame.

Optically, the prism layer is a 0-degree prism lens or a 90-degree prism lens; the long side of the 0-degree prism lens is parallel to the upper side and the lower side of the frame; and the long side of the 90-degree prism lens is parallel to the left side and the right side of the frame.

When the prism layer is a 0-degree prism lens, when the prism layer is partially overlapped with the upper side or the lower side of the frame, the width of the prism layer extended from the upper side or the lower side of the frame is not more than 0.7 mm; and when the prism layer and the frame are not overlapped, the difference of the spacing between the prism layer and the upper side or the lower side of the frame is 0 to 3 mm.

When the prism layer is a 90-degree prism lens, when the prism layer is partially overlapped with the left side or the right side of the frame, the width of the prism layer extended from the left side or the right side of the frame is not more than 0.7 mm; and when the prism layer and the frame are not overlapped, the difference of the spacing between the prism layer and the left side or the right side of the frame is 0 to 3 mm.

Compared with the prior art, the narrow-frame LCD module provided by the present invention effectively shortens the dark band on the circumference of the frame on the LCD module by accurately controlling the width of the prism layer, quantitatively controls the overlap width or the mutual spacing between the prism layer and the frame after several trials on the premise of guaranteeing the display effect of the LCD panel, obviously shortens the dark band produced by the imaging of the frame on the prism layer by cutting the prism layer in the optical film, and hence optimizes the display quality of the LCD module.

### BRIEF DESCRIPTION OF THE DRAWINGS

FIG. 1 is a schematic structural view of the traditional narrow-frame LCD module;

FIG. 2 is a light path diagram illustrating the imaging of a frame on a prism layer in the traditional narrow-frame LCD module;

FIG. 3 is a schematic structural view of an embodiment 1 of a narrow-frame LCD module provided by the present invention;

FIG. 4 is a light path diagram illustrating the imaging of a frame on a prism layer in the narrow-frame LCD module provided by the present invention;

FIG. 5 is a diagram illustrating the imaging effect of the frame before cutting on a 0-degree prism lens in the narrow-frame LCD module provided by the present invention;

FIG. 6 is a diagram illustrating the imaging effect of the frame before cutting on a 90-degree prism lens in the narrow-frame LCD module provided by the present invention;

FIG. 7 is a diagram illustrating the imaging effect of the frame after cutting on the 0-degree prism lens in the narrow-frame LCD module provided by the present invention;

FIG. 8 is a diagram illustrating the imaging effect of the frame after cutting on the 90-degree prism lens in the narrow-frame LCD module provided by the present invention; and

FIG. 9 is a schematic structural diagram of an embodiment 2 of the narrow-frame LCD module provided by the present invention.

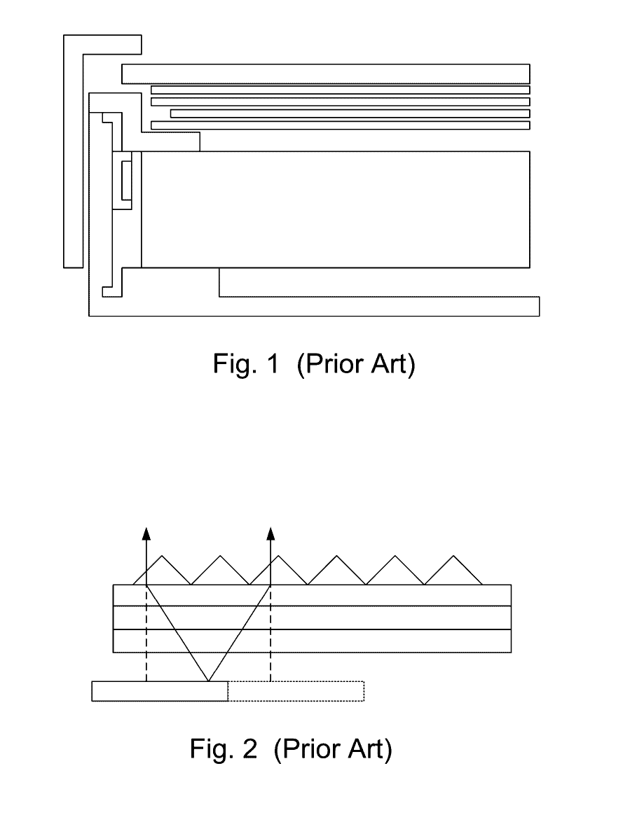

### DETAILED DESCRIPTION OF THE PREFERRED EMBODIMENTS

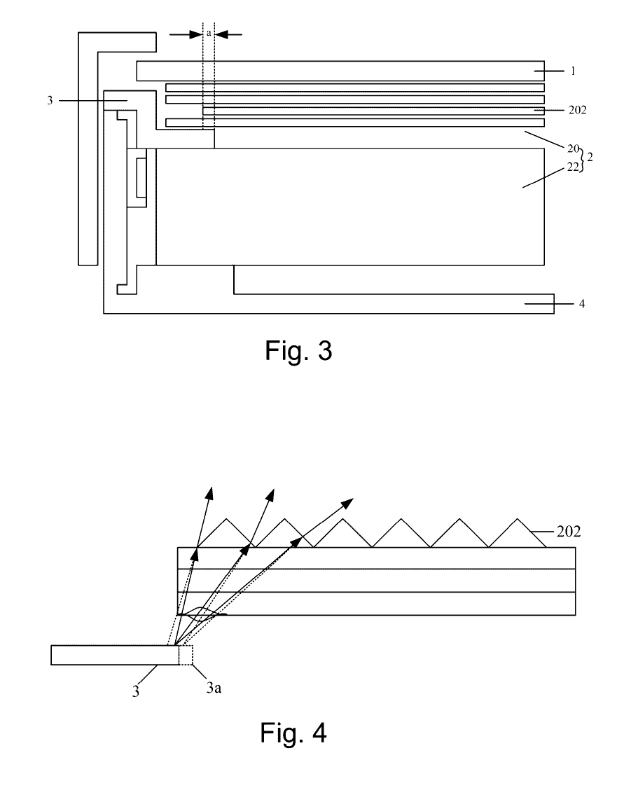

In a narrow-frame LCD module, in the light-emitting process of an LCD panel, a frame configured to fix the peripheral wall of the LCD panel tends to be imaged and projected on the LCD panel to produce a dark band, and hence the overall imaging effect on the LCD panel can be affected. In order to eliminate the marginal dark band, as illustrated in FIG. 3, the present invention provides a narrow-frame LCD module, which comprises: an LCD panel 1; a light guide module 2 including at least one group of optical films 20 and a light guide plate 22 disposed at the rear of the optical films 20; and a frame 3 erected on the light guide plate 22 and configured to support the edges of the optical films 20, wherein a prism layer 202 is disposed among the optical films 20; the prism layer 202 and the frame 3 are partially overlapped or not overlapped; and when the prism layer and the frame are partially overlapped, the width of the prism layer 202 extended from the frame 3 is not more than 2 mm so as to shorten a dark band produced by the refraction imaging of the frame 3 on the edge of the LCD panel 1.

Wherein four walls of the LCD panels 1 are fixed by an outer frame, and the LCD panel 1 is fixed by being clamped into an inner cavity formed by the outer frame. The light guide module 2 includes the optical films 20 and the light guide plate 22; the optical films 20 cover the light guide plate 22; and an image is imaged on the LCD panel 1 through the optical films 20. The LCD module further comprises a radiating assembly 4; one end of the frame 3 is fixed on the radiating assembly 4 and the other end of the frame 3 is overlapped on the light guide plate 22; the light guide plate 22 is disposed at the rear of the optical films 20; and the optical films 20 are supported above the light guide plate 22 through the frame 3.

The optical film 20 adopts a multi-layer structure, and a prism layer 202 is disposed among the optical films which are parallel to and overlapped with each other. In the narrow-frame LCD module provided by the present invention, the prism layer 202 is the third layer; and the dark band produced by the projection imaging of the frame 3 on the prism layer 202 is shortened by the control of the overlap area between the prism layer 202 and the frame 3. The position relationship between the prism layer and the frame is illustrated through the following two embodiments.

As illustrated in FIG. 4 which is a light path diagram illustrating the imaging of the frame after cutting on the prism layer, a dotted light path is a reverse extension line of light on the upper side, and a dotted box illustrates an image formed by the refraction of the light through the prism layer. As the prism layer 202 is shortened, less frame 3 is shielded by the prism layer 202, and hence the original projection image of the frame is shortened or eliminated, namely the dark band 3a is shortened or eliminated.

### Embodiment 1

As illustrated in FIG. 3, when the prism layer 202 and the frame 3 are overlapped with each other, the prism layer 202 and the frame 3 are partially overlapped; the width a of the prism layer 202 extended from the frame 3 is not more than 0.7 mm, preferably 0.5 mm, namely the width a of the prism layer 202 covering the frame 4 is not more than 0.7 mm; and hence the dark band produced by the imaging of the frame 3 through the prism layer 202 is basically eliminated. Therefore, the dark band on the circumference of the frame on the LCD panel can be effectively shortened by the accurate control of the width of the prism layer 202.

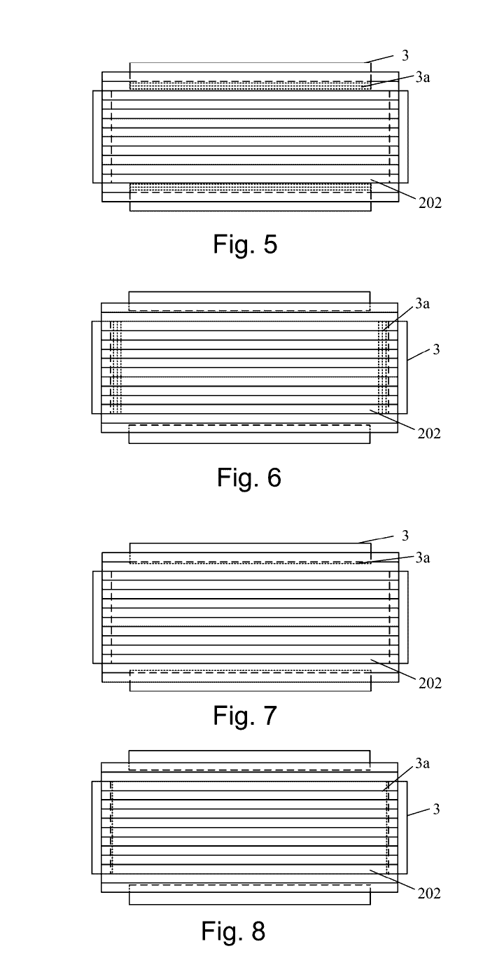

The prism layer 202 may be a 0-degree prism lens or a 90-degree prism lens. As illustrated in FIG. 5, the long side of the 0-degree prism lens is parallel to the upper side and the lower side of the frame 3. As illustrated in FIG. 6, the long side of the 90-degree prism lens is parallel to the left side and the right side of the frame 3.

When the 0-degree prism lens is adopted, before cutting, the frame on the upper side and the lower side is imaged through the prism layer to form the dark band. At this point, as illustrated in FIG. 7, the upper side or the lower side of the prism layer 202 is cut in such a way that the width of the prism layer 202 extended from the upper side or the lower side of the frame 3 is not more than 0.7 mm when the prism layer 202 is partially overlapped with the upper side or the lower side of the frame 3, and hence the dark band produced by the imaging of the frame 3 through the prism layer 202 is basically eliminated.

When the 90-degree prism lens is adopted, before cutting, the frame on the left side and the right side is imaged through the prism layer to form the dark band. At this point, as illustrated in FIG. 8, the left side or the right side of the prism layer 202 is cut in such a way that the width of the prism layer 202 extended from the left side or the right side of the frame 3 is not more than 0.7 mm when the prism layer 202 is partially overlapped with the left side or the right side of the frame 3, and hence the dark band produced by the imaging of the frame 3 through the prism layer 202 is basically eliminated.

### Embodiment 2

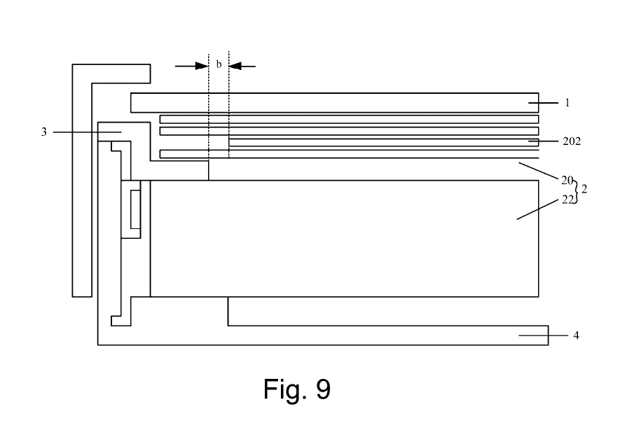

As illustrated in FIG. 9, when the prism layer 202 and the frame 3 are not overlapped, the difference of the spacing b between the prism layer 202 and the frame 3 is 0 to 3 mm, preferably 2.5 mm, namely the distance b of the prism layer 202 extended from the frame is not more than 3 mm. Therefore, the dark band produced by the imaging of the frame 3 through the prism layer 202 is completely eliminated, and hence the display effect of an image on the LCD panel is not affected.

When the 0-degree prism lens is adopted, before cutting, the frame on the upper side and the lower side is imaged through the prism layer to form the dark band. At this point, the upper side or the lower side of the prism layer 202 is cut in such a way that the dark band produced by the imaging of the frame 3 through the prism layer 202 is completely eliminated when the spacing between the prism layer 202 and the upper side or the lower side of the frame 3 is 0 to 3 mm.

When the 90-degree prism lens is adopted, before cutting, the frame on the left side and the right side is imaged through the prism layer to form the dark band. At this point, the left side or the right side of the prism layer 202 is cut in such a way that the dark band produced by the imaging of the frame 3 through the prism layer 202 is completely eliminated when the spacing between the prism layer 202 and the left side or the right side of the frame 3 is 0 to 3 mm.

The narrow-frame LCD module provided by the present invention effectively shortens the dark band on the circumference of the frame on the LCD module by accurately controlling the width of the prism layer, quantitatively controls the overlap width or the mutual spacing between the prism layer and the frame after several trials on the premise of guaranteeing the display effect of the LCD panel, obviously shortens the dark band produced by the imaging of the frame on the prism layer by cutting the prism layer in the optical film, and hence optimizes the display quality of the LCD module.

What is claimed is:

1. A narrow-frame liquid crystal display (LCD) module, comprising:
an LCD panel;
a light guide module including at least one group of optical films and a light guide plate disposed at the rear of the optical films; and
a frame erected on the light guide plate and configured to support the edges of the optical films, wherein
a prism layer is disposed among the optical films; the prism layer and the frame are partially overlapped or not overlapped; when the prism layer and the frame are partially overlapped, the width of the prism layer extended from the frame is not more than 0.7 mm so as to shorten a dark band produced by the dioptric imaging of the frame on the edge of the LCD panel; and when the prism layer and the frame are not overlapped, the difference of the spacing between the prism layer and the frame is 0 to 3 mm.

2. The narrow-frame LCD module according to claim 1, wherein the LCD module further comprises a radiating assembly and a light guide plate; one end of the frame is fixed on the radiating assembly and the other end of the frame is overlapped on the light guide plate; the light guide plate is disposed at the rear of the optical film; the optical film is supported above the light guide plate through the frame.

3. The narrow-frame LCD module according to claim 2, wherein the prism layer is a 0-degree prism lens or a 90-degree prism lens.

4. The narrow-frame LCD module according to claim 3, wherein the long side of the 0-degree prism lens is parallel to the upper side and the lower side of the frame; and the long side of the 90-degree prism lens is parallel to the left side and the right side of the frame.

5. The narrow-frame LCD module according to claim 4, wherein when the prism layer is a 0-degree prism lens, when the prism layer is partially overlapped with the upper side or the lower side of the frame, the width of the prism layer extended from the upper side or the lower side of the frame is not more than 0.7 mm; and when the prism layer and the frame are not overlapped, the difference of the spacing between the prism layer and the upper side or the lower side of the frame is 0 to 3 mm.

6. The narrow-frame LCD module according to claim 4, wherein when the prism layer is a 90-degree prism lens, when the prism layer is partially overlapped with the left side or the right side of the frame, the width of the prism layer extended from the left side or the right side of the frame is not more than 0.7 mm; and when the prism layer and the frame are not overlapped, the difference of the spacing between the prism layer and the left side or the right side of the frame is 0 to 3 mm.

7. A narrow-frame LCD module, comprising: an LCD panel;
a light guide module including at least one group of optical films and a light guide plate disposed at the rear of the optical films; and
a frame erected on the light guide plate and configured to support the edges of the optical films, wherein
a prism layer is disposed among the optical films; the prism layer and the frame are partially overlapped or not overlapped; and when the prism layer and the frame are partially overlapped, the width of the prism layer extended from the frame is not more than 2 mm so as to shorten a dark band produced by the dioptric imaging of the frame on the edge of the LCD panel.

8. The narrow-frame LCD module according to claim 7, wherein when the prism layer and the frame are not overlapped, the difference of the spacing between the prism layer and the frame is 0 to 3 mm.

9. The narrow-frame LCD module according to claim 7, wherein the LCD module further includes a radiating assembly and a light guide plate; one end of the frame is fixed on the radiating assembly and the other end of the frame is overlapped on the light guide plate; the light guide plate is disposed at the rear of the optical film; and the optical film is supported above the light guide plate through the frame.

10. The narrow-frame LCD module according to claim 9, wherein the prism layer is a 0-degree prism lens or a 90-degree prism lens.

11. The narrow-frame LCD module according to claim 10, wherein the long side of the 0-degree prism lens is parallel to the upper side and the lower side of the frame.

12. The narrow-frame LCD module according to claim 10, wherein the long side of the 90-degree prism lens is parallel to the left side and the right side of the frame.

13. The narrow-frame LCD module according to claim 11, wherein when the prism layer is a 0-degree prism lens, when the prism layer is partially overlapped with the upper side or the lower side of the frame, the width of the prism layer extended from the upper side or the lower side of the frame is not more than 0.7 mm; and when the prism layer and the frame are not overlapped, the difference of the spacing between the prism layer and the upper side or the lower side of the frame is 0 to 3 mm.

14. The narrow-frame LCD module according to claim 12, wherein when the prism layer is a 90-degree prism lens, when the prism layer is partially overlapped with the left side or the right side of the frame, the width of the prism layer extended from the left side or the right side of the frame is not more than 0.7 mm; and when the prism layer and the frame are not overlapped, the difference of the spacing between the prism layer and the left side or the right side of the frame is 0 to 3 mm.
